(19) United States
(12) Patent Application Publication
(10) Pub. No.: US 2006/0263714 A1
(43) Pub. Date: Nov. 23, 2006

(54) Resist composition and organic solvent for removing resist

(76) Inventor: Doek-Man Kang, Sungnam-city (KR)

Correspondence Address: AZ ELECTRONIC MATERIALS USA CORP.;ATTENTION: INDUSTRIAL PROPERTY DEPT., 70 MEISTER AVENUE, SOMERVILLE, NJ, 08876, US

(21) Appl. No.: 10/551,215

(22) PCT Filed: Apr. 23, 2004
(86) PCT No.: PCT/KR04/00935

§ 371 Date: Sep. 28, 2005

(30) Foreign Application Priority Data
Apr. 24, 2003 (KR) 10-2003-0026029

(51) Int. Cl. G03C 1/00

(52) U.S. Cl. 430/270.1

(57) ABSTRACT

The present invention provides a resist composition comprising benzyl alcohol or its derivatives as an organic solvent. The present invention also provides an organic solvent for removing a resist, wherein the organic solvent comprises benzyl alcohol or its derivatives. The resist composition of the present invention is used in a lithography process for forming a micro-pattern using a difference in the solubility between the irradiated part and the non-irradiated part by irradiation with UV rays to greatly improve the uniformity of the film thickness upon coating of the thin film. In addition, the organic solvent according to the present invention can be used to wash the device, which comes into contact with the photosensitive material in the course of the microcircuit forming process, by removing the photosensitive material from the device. It also can remove the photosensitive material remaining on the undesired parts of the substrate on which the photosensitive material is coated.

### TECHNICAL FIELD

The present invention relates to a resist composition that improves uniformity of a thin film upon thin film-coating, necessary for a lithographic process.

### BACKGROUND ART

Rapid development of the semiconductor and the flat board display industry greatly has increased the demand for a resist composition used mainly for semiconductors and flat board displays. Further, as the wafer of a semiconductor as well as the substrate of the flat board display are becoming larger in size, it has become more important to provide a thin film with uniform thickness to reduce inferiority and increase productivity. As such resist composition, i) a positive photoresist composition containing a resin for forming a thin film, a sensitizer showing a sensitive response to light, and an organic solvent; and ii) a negative photoresist composition containing a resin, acid or radical generating compound, a crosslinker and an organic solvent, are widely used.

As the organic solvent for dissolving solid components of the above resist compositions and then coating them on the substrate, ethylene glycol monoethylether acetate (hereinafter referred to as “EGMEA”) had been widely used conventionally. The reason is that EGMEA can easily dissolve a resin and a sensitizer (or acid or radical generating compound) and can be safely stored for a long time. However, since an IBM report published that EGMEA can threaten biological safety, the necessity to develop a new solvent harmless to humans has been on the rise.

Compared with EGMEA, propylene glycol monomethylether acetate (hereinafter referred to as “PGMEA”) shows superior biological safety, has an excellent solubility of the resin and the sensitizer (or acid or radical generating compound) and has excellent coating uniformity upon thin film coating. Therefore, PGMEA has been used as the typical main solvent in this field up to now. However, as the size of the substrate to be coated increases, it is getting harder and harder to provide a uniform film thickness from PGMEA alone.

### DISCLOSURE OF INVENTION

The present invention is to provide a resist composition which is harmless to humans and can increase the uniformity of a thin film on a large substrate by solving the above mentioned problems.

The purpose of the present invention is to provide a resist composition which exhibits increased flowability upon coating, and increases the uniformity and storage stability of the thin film.

Another purpose of the present invention is to provide an organic solvent for washing the device, which comes into contact with the photosensitive material in the course of the microcircuit forming process, by removing the photosensitive material remaining on the device and for removing the photosensitive material remaining on the undesired parts of the substrate on which the photosensitive material is coated.

The present invention provides a resist composition comprising benzyl alcohol or its derivatives as an organic solvent. Specifically, the present invention provides a positive photoresist composition comprising an alkaline soluble novolak resin, a naphthoquinonediazide photosensitive compound and an organic solvent, characterized in that the organic solvent comprises benzyl alcohol or its derivatives; and a negative photoresist composition comprising an alkaline soluble acrylic resin or novolak resin, a strong acid or a radical generating compound by irradiation with UV rays, a crosslinker and an organic solvent, characterized in that the organic solvent comprises benzyl alcohol or its derivatives.

Further, the present invention provides an organic solvent for removing a resist, wherein the organic solvent comprises benzyl alcohol or its derivatives, which can remove the photosensitive material remaining on the device, which comes into contact with the photosensitive material in the course of the microcircuit forming process, to be used to wash the device and, which can remove the photosensitive material remaining on undesired parts of the substrate.

The organic solvent used in the present invention comprises benzyl alcohol or benzyl alcohol derivatives. As the benzyl alcohol derivative, the compound which is prepared by a condensation reaction of benzyl alcohol and ethylene oxide or propylene oxide and has a total molecular weight of at most 10,000 can be used. As the organic solvent, the solvent containing only benzyl alcohol or its derivatives can be used. Further, the solvent wherein benzyl alcohol or its derivatives is mixed with another solvent, such as PGMEA, ethyl lactate (hereinafter referred to as “EL”) and propylene glycol monomethyl ether (hereinafter referred to as “PGME”), can also be used. The solvent to be mixed with benzyl alcohol or its derivatives are not limited to any particular one and solvents of mixtures of two or more solvents can also be used.

In the organic solvents, the content of benzyl alcohol is preferably 1 to 35% by weight and more preferably 5 to 30% by weight, based on 100% by weight of the organic solvent, irrespective of the kind of resist.

When the content of benzyl alcohol is less than 1% by weight or exceeds 35% by weight, the coating uniformity is lowered and the flowability decreases. However, when the content of benzyl alcohol falls within the above range, the coating uniformity and the flowability are excellent.

<Positive Photoresist Composition>

In the resist compositions according to the present invention, the positive photoresist composition is sensitive to UV rays, and the part irradiated by UV light is dissolved in a developing solution. This composition comprises an alkaline soluble novolak resin and a naphthoquinonediazide photosensitive compound in addition to the above organic solvent. The novolak resin is a polymer material prepared by reacting an aromatic alcohol, such as phenol, cresol and xylenol, with formaldehyde in the presence of an acid catalyst. This resin is a basic material forming a thin film, which is soluble in an alkaline solution. The photosensitive compound is a material sensitive to UV light and includes triazines, imidazoles, acetophenones, naphthoquinone diazides and the like.

In the present invention, preferably, the naphthoquinone diazide compounds are used. This compound is prepared by ester reaction of polyhydroxybenzophenone and naphthoquinone diazide. The naphthoquinone diazide sulfonic acid ester is most preferred.

<Negative Photoresist Composition>

In the resist compositions according to the present invention, the negative photoresist composition is sensitive to UV rays, and the part irradiated by UV light is not dissolved in a developing solution. This composition comprises an alkaline soluble acrylic resin or novolak resin, a strong acid or a radical generating compound by irradiation with UV rays and a crosslinker in addition to the above organic solvent. The alkaline soluble acrylic resin may include a copolymer, such as methyl meta acrylate, meta acrylic acid and n-butyl acrylate. Further, the strong acid or radical generating compound by irradiation with UV rays includes benzophenone derivatives, triazine derivatives or sulfonium derivatives. The crosslinker can include epoxy resin, epoxy acrylate resin, melamine resin, alkoxy benzene resin, diphenyl ether resin or styrene resin. The novolak resin is the same as that used in the positive photoresist composition.

The resist composition according to the present invention can be coated on a substrate by spin coating, roller coating, slit or spray coating methods to form a thin film coat.

Spin coating is a method of coating a thin film using centrifugal force generated by rotation. For a semiconductor and lithography display, this method is mainly used. The bad flowability of the resist in this method makes the difference in the film thickness between the central and edge portion of the substrate increase to lower the coating uniformity of the thin film. According to the present invention, since the flowability of the resist is excellent, such problem does not exist.

Roller coating is a method of coating a thin film while passing the substrate into a space between two rollers revolving in opposite directions to each other. This method provides inferior uniformity compared to a thin film formed by the revolving spin coating method. Also in the roller coating method, a plurality of grooves are presented on the surface of roller. The resist covers the grooves and then it carves in relief as it stands. After a period of time has passed, the carved resist spreads out to make a coat. Accordingly, in order to obtain uniform film thickness from this method, the resist composition should spread out rapidly and uniformly. The resist composition containing the organic solvent according to the present invention having good solubility and excellent uniformity can provide uniform film thickness.

Slit and spray coating is a method to coat a resist by using nozzles of several tens to hundreds micrometer. In this method, a quick and uniform diffusion feature of the resist sprayed through nozzles becomes a very important factor in the uniformity of the thin film.

The content of the solids component of the resist composition used in the present invention is preferably 16 to 35% by weight for the spin coating, preferably 20 to 50% by weight for the roller coating, and preferably 5 to 20% by weight for the slit coating.

Controlling the mixing ratio in the solvent when using the composition of the present invention can maximize the improvement in process capability, for example, an increase in a suitable exposure range, a decrease in a deviation in the film thickness upon formation of a coated film, and a reduction in change in the fine line width due to a deviation in the baking temperature.

On the other hand, the photosensitive material may remain on the device which comes to contact with the photosensitive material in the course of the microcircuit forming process and in addition, the photosensitive material may remain on an undesired part of the substrate in coating the resist composition on the substrate. For the former, it is necessary to wash the device itself by removing the photosensitive material and for the latter, it is also necessary to remove the photosensitive material. When the organic solvent comprising benzyl alcohol or its derivatives is used, such photosensitive material can be completely easily removed. The reason is that the photosensitive material is highly soluble in the organic solvent comprising benzyl alcohol or its derivatives. Since the organic solvent used in the resist composition can also be used, it is advantages as to cost and can be conveniently used.

The present invention will be discussed in detail with the following examples. However, it should not be interpreted that the scope of the instant invention is limited to only the examples.

### BEST MODE FOR CARRYING OUT THE INVENTION

### Example 1

A solid comprising of 70% by weight of cresol novolak resin having a weight-average molecular weight of 7,000 prepared by a condensation reaction of cresol and formaldehyde with an oxalic acid catalyst and 30% by weight of naphthoquinone diazidosulfonic ester as a photosensitive compound was mixed with a mixture of 99% by weight of PGMEA and 1% by weight of benzyl alcohol (hereinafter referred to as “BA”) in a 2.5:7.5 ratio (by weight) to be dissolved. The resulting product was filtered through the 0.2 um filter and as a result, a resist composition was prepared.

### Example 2

The resist composition was prepared in the same manner as in Example 1 except that a mixture of PGMEA and BA in a ratio of 95:5% by weight was used as an organic solvent.

### Example 3

The resist composition was prepared in the same manner as in Example 1 except that a mixture of PGMEA and BA in a ratio of 90:10% by weight was used as an organic solvent.

### Example 4

The resist composition was prepared in the same manner as in Example 1 except that a mixture of PGMEA and BA in a ratio of 80:20% by weight was used as an organic solvent.

### Example 5

The resist composition was prepared in the same manner as in Example 1 except that a mixture of PGMEA and BA in a ratio of 70:30% by weight was used as an organic solvent.

### Example 6

The resist composition was prepared in the same manner as in Example 1 except that a mixture of PGMEA and BA in a ratio of 65:35% by weight was used as an organic solvent.

### Comparative Example 1

The resist composition was prepared in the same manner as in Example 1 except that 100% by weight of PGMEA was used as an organic solvent.

After coating the resist composition according to examples 1 to 6 and comparative example 1 on a glass substrate having a 370 mm wide by 470 mm long and 0.7 mm thick, by using the spin coating method, a deviation in the film thickness was measured using a NANOSPEC M 6500 instrument, a device for measuring film thickness. The results are shown in table 1.

TABLE 1
Thin-film coating characteristics of the photosensitive
resin according to the kind of solvent

| | Coating Uniformity(%) | Length of flow (mm) |
|---|---|---|
| Example 1 | 3.13% | 23 |
| Example 2 | 2.92% | 31 |
| Example 3 | 2.75% | 47 |
| Example 4 | 2.97% | 38 |
| Example 5 | 2.93% | 32 |
| Example 6 | 3.05% | 30 |
| Comparative | 3.16% | 21 |
| Example 1 | | |

As can be seen in the above Table 1, the resist compositions according to Examples 1 to 6 of the present invention comprising benzyl alcohol have excellent coating uniformity and flowability as compared with the resist composition of comparative example 1 which does not include benzyl alcohol.

### Example 7

A solid comprising of 24% by weight of an alkaline soluble acrylic resin having a weight-average molecular weight of 20,000-40,000, 14% by weight of multifunctional acrylic monomer, 5% by weight of an alpha amino ketone radical photo initiator and 57% by weight of an organic pigment was mixed with a mixture of 99% by weight of PGMEA and 1% by weight of benzyl alcohol in a 2.0:8.0 ratio (by weight) to be dissolved. The resulting product was filtered through the 0.2 um filter and as a result, a resist composition was prepared.

### Example 8

The resist composition was prepared in the same manner as in Example 7 except that a mixture of PGMEA and BA in a ratio of 95:5% by weight was used as an organic solvent.

### Example 9

The resist composition was prepared in the same manner as in Example 7 except that a mixture of PGMEA and BA in a ratio of 90:10% by weight was used as an organic solvent.

### Example 10

The resist composition was prepared in the same manner as in Example 7 except that a mixture of PGMEA and BA in a ratio of 80:20% by weight was used as an organic solvent.

### Example 11

The resist composition was prepared in the same manner as in Example 7 except that a mixture of PGMEA and BA in a ratio of 70:30% by weight was used as an organic solvent.

### Example 12

The resist composition was prepared in the same manner as in Example 7 except that a mixture of PGMEA and BA in a ratio of 65:35% by weight was used as an organic solvent.

### Comparative Example 2

The resist composition was prepared in the same manner as in Example 7 except that 100% by weight of PGMEA was used as an organic solvent.

After coating the resist composition according to examples 7 to 12 and comparative example 2 on a glass substrate being a 370 mm wide by 470 mm long and 0.7 mm thick, by using the spin coating method, a deviation in the film thickness was measured using a NANOSPEC M 6500 instrument, a device for measuring film thickness. The results are shown in table 2.

TABLE 2
Thin-film coating characteristics of the photosensitive
resin according to the kind of solvent

| | Coating Uniformity(%) | Length of flow (mm) |
|---|---|---|
| Example 7 | 3.98% | 22 |
| Example 8 | 3.01% | 35 |
| Example 9 | 2.35% | 49 |
| Example 10 | 2.54% | 40 |
| Example 11 | 2.75% | 36 |
| Example 12 | 3.04% | 32 |
| Comparative | 4.03% | 20 |
| Example 2 | | |

As can be seen in the above Table 2, the resist compositions according to Examples 7 to 12 of the present invention containing benzyl alcohol have excellent coating uniformity and flowability as compared with the resist composition of comparative example 2 not containing benzyl alcohol.

### Example 13

The photoresist material, naphthoquinone diazidesulfonic acid ester, is added into 100 g of organic solvent solution, i.e., a mixed solution of PGMEA and BA in ratio of 99 wt. %:1 wt. %, 95 wt. %:5 wt. %, 90 wt. %:10 wt. %, 80 wt. %:20 wt. %, 60 wt. %:40 wt. %, 40 wt. %:60 wt. %, 20 wt. %:80 wt. % or a solution consisting of PGMEA 100 wt. %, and stirred at 200 rpm. The maximum amount of the photosensitive material dissolved for one hour is measured. The results are shown in Table 3 below.

TABLE 3
Solubility of the photosensitive material
according to the kind of solvent

| PGMEA (unit: wt. %) | BA (unit: wt. %) | Solubility (unit: g) |
|---|---|---|
| 99 | 1 | 2.5 |
| 95 | 5 | 4 |
| 90 | 10 | 8 |
| 80 | 20 | 50 |
| 60 | 40 | 50 |
| 40 | 60 | 70 |
| 20 | 80 | 80 |
| 100 | 0 | 2 |

As a result of the experiment, it has been shown that the organic solvent comprising benzyl alcohol has significantly superior solubility of the photosensitive material as compared with the organic solvent not comprising benzyl alcohol.

Effect of Invention

The resist composition comprising benzyl alcohol or its derivatives as an organic solvent, which is coated on the substrate, provides excellent flowability upon formation of a thin film, reduced deviation in the film thickness and increased coating uniformity. Further, this organic solvent is useful either in washing the device in situ or in removing photosensitive material remaining on the undesired part upon coating, which makes a lithography process economical and convenient.

1. A resist composition comprising an alkaline soluble novolak resin, a naphtoquinonediazide photosensitive compound and an organic solvent, characterized in that the organic solvent comprises benzyl alcohol or its derivatives.

2. The resist composition according to claim 1, characterized in that the organic solvent comprises 1% by weight to 35% by weight of benzyl alcohol or its derivatives.

3. A photosensitive resist composition comprising an alkaline soluble acrylic resin or novolak resin, a strong acid or a radical generating compound by irradiating UV ray, a crosslinker and an organic solvent, characterized in that the organic solvent comprises benzyl alcohol or its derivatives.

4. The resist composition according to claim 3, characterized in that the organic solvent comprises 1% by weight to 35% by weight of benzyl alcohol or its derivatives.

5. An organic solvent for removing a resist, comprising benzyl alcohol or its derivatives.
